(19) United States
(12) Patent Application Publication
(10) Pub. No.: US 2016/0281603 A1
(43) Pub. Date: Sep. 29, 2016

(54) GAS TURBINE ENGINE FLUID HEAT MANAGEMENT SYSTEM

(71) Applicant: ROLLS-ROYCE PLC, London (GB)

(72) Inventor: Ajith APPUKUTTAN, Leicester (GB)

(73) Assignee: ROLLS-ROYCE PLC, London (GB)

(21) Appl. No.: 15/062,349

(22) Filed: Mar. 7, 2016

(30) Foreign Application Priority Data
Mar. 27, 2015 (GB) 1505255.8

(51) Int. Cl. F02C 7/141; F02C 3/04

(52) U.S. Cl. CPC F02C 7/141; F02C 3/04

(57) ABSTRACT

A fluid heat management system for an aircraft gas turbine engine. The system includes an oil to air heat exchanger configured to transfer heat from engine oil to bypass air, an oil to fuel heat exchanger configured to transfer heat from engine oil to fuel, and a phase change material in thermal contact with the oil upstream of the oil to fuel heat exchanger. The phase change material has a phase change temperature at a predetermined fuel target temperature.

### FIELD OF THE INVENTION

The present invention relates to a gas turbine engine fluid heat management system, and a method of managing heat in a gas turbine engine fluid system, particularly a gas turbine engine oil system.

### BACKGROUND OF THE INVENTION

FIG. 1 shows a high-bypass gas turbine engine 10. The engine 10 comprises, in axial flow series, an air intake duct 11, an intake fan 12, a bypass duct 13, an intermediate pressure compressor 14, a high pressure compressor 16, a combustor 18, a high pressure turbine 20, an intermediate pressure turbine 22, a low pressure turbine 24 and an exhaust nozzle 25. The fan 12, compressors 14, 16 and turbines 20, 22, 24 all rotate about the major axis of the gas turbine engine 10 and so define the axial direction of gas turbine engine.

Air is drawn through the air intake duct 11 by the intake fan 12 where it is accelerated. A significant portion of the airflow is discharged through the bypass duct 13 generating a corresponding portion of the engine 10 thrust. The remainder is drawn through the intermediate pressure compressor 14 into what is termed the core of the engine 10 where the air is compressed. A further stage of compression takes place in the high pressure compressor 16 before the air is mixed with fuel and burned in the combustor 18. The resulting hot working fluid is discharged through the high pressure turbine 20, the intermediate pressure turbine 22 and the low pressure turbine 24 in series where work is extracted from the working fluid. The work extracted drives the intake fan 12, the intermediate pressure compressor 14 and the high pressure compressor 16 via shafts 26, 28, 30. The working fluid, which has reduced in pressure and temperature, is then expelled through the exhaust nozzle 25 and generates the remaining portion of the engine 10 thrust.

The engine is lubricated with oil. The oil also serves to cool parts of the engine 10, and so a large quantity of heat from the engine is transferred to the oil in use. This heat must be removed in order for the oil to be recirculated—otherwise, the oil temperature would become excessive, preventing the oil from being effective for cooling, and reducing the life of the oil.

FIG. 2 shows a fluid flow diagram of a prior oil system for an aircraft engine such as that shown in FIG. 1. The engine oil temperature is controlled by a Fuel oil heat exchanger (FOHE) and air oil heat exchanger (AOHE). The FOHE is used at all operating conditions, whilst the AOHE is used at conditions when the thermal capacity of the fuel is insufficient to provide adequate oil cooling, i.e. at low power conditions. Use of the AOHE is undesirable, since heat transferred to the AOHE is lost to the engine thermodynamic cycle, thereby increasing Specific Fuel Consumption (SFC) of the engine 10.

The thermal capacity of fuel varies significantly across a flight profile as it is proportional to the mass flow rate of fuel. The heat rejected into oil does not however vary significantly. Consequently, in conditions where the fuel is unable to sink all the heat from the oil (such as during low engine power conditions), the AOHE sinks the heat from oil to the bypass duct air.

However, it has been discovered by the inventors that there still exist problems with such arrangements where power is rapidly reduced as the aircraft transitions to descent from the cruise condition. During this condition, in some cases, the fuel flow rate may drop by a ratio of five. For a few minutes at the beginning of the operation, the AOHE is unable to control the temperature of oil, and as a result the heat from the oil causes a large rise in the temperature of the fuel. This temperature rise leads to fuel coking, thus affecting the life of fuel system. Alternatively, if the AOHE is designed to accommodate this large transient heat input, the size and weight of the AOHE would have to be significantly increased, leading to increased overall weight and cost of the system.

The present invention describes a fluid heat management system and a method of managing heat within an oil system of a gas turbine engine which seeks to overcome some or all of the above problems.

The above is provided to better explain the advantages of the invention, and does not represent an admission of prior art.

### SUMMARY OF THE INVENTION

According to a first aspect of the present disclosure, there is provided a fluid heat management system for an aircraft gas turbine engine, the system comprising: an oil to air heat exchanger configured to transfer heat from engine oil to bypass air; an oil to fuel heat exchanger configured to transfer heat from engine oil to fuel; and a phase change material in thermal contact with oil upstream of the oil to fuel heat exchanger, wherein the phase change material has a phase change temperature at a predetermined fuel target temperature.

Accordingly, the fluid heat management system of the present disclosure prevents coking of fuel where engine power is suddenly reduced, such as during the transition between cruise and descent conditions in flight. This arrangement is thought to have a significantly smaller weight penalty compared to prior solutions (such as increasing the size of the oil to air heat exchanger). This solution may also reduce the amount of heat lost to the thermodynamic cycle, since the phase change material stores heat to be later transferred to the fuel, rather than rejecting heat out of the engine. The arrangement is also relatively low cost compared to increasing the size or performance of the air oil heat exchanger.

The phase change material may be provided within a further heat exchanger. The further heat exchanger may be provided downstream of the air to oil heat exchanger (AOHE). Advantageously, the oil is cooled by the AOHE prior to coming into thermal contact with the phase change material. Consequently, a phase change material having a lower phase change temperature can be chosen. Alternatively, the phase change material may be located within the AOHE or FOHE.

The system may comprise a bypass arrangement configured to selectively bypass oil around at least the oil to air heat exchanger. The bypass arrangement may be configured to selectively bypass oil around the phase change material, such that the phase change material is not in thermal contact with the oil. Advantageously, heat transferred to the further heat exchanger can be controlled without the requirement for a further valve or bypass arrangement. Consequently, the existing control arrangement can be used without modification, thereby reducing the costs associated with the disclosed arrangement.

The target temperature may be between 100° C. and 120° C., and preferably is approximately 110° C.

In one embodiment, the further heat exchanger may have a heat capacity of between 1 and 2 MJ, and preferably has a heat capacity of approximately 1.7 MJ.

The phase change material may comprise a salt hydrate of the general formula MₙH₂O, where M is a salt. The phase change material may comprise one or more of Magnesium chloride hexahydrate (MgCl₂.6H₂O) and hydrate of potassium aluminium sulphate (also known as Alum and having the chemical formula KAl(SO₄)₂.12H₂O). The system may comprise between 1 and 10 litres of phase change material, and in one embodiment may comprise approximately 4 litres of phase change material.

According to a second aspect of the present disclosure, there is provided a gas turbine engine comprising a gas turbine engine fluid heat management system in accordance with the first aspect of the present disclosure.

According to a third aspect of the present disclosure, there is provided a method of managing heat within an oil system of a gas turbine engine, the method comprising: transferring heat from oil to fuel via an fuel to oil heat exchanger (FOHE); selectively transferring heat from oil to air via an air to oil heat exchanger (AOHE); and selectively transferring heat from oil to a phase change material having a phase change temperature at a predetermined target fuel temperature.

### BRIEF DESCRIPTION OF THE DRAWINGS

FIG. 1 shows a cross sectional view of a gas turbine engine;

FIG. 2 shows a fluid flow diagram of a prior fluid heat management system suitable for use with the gas turbine engine of FIG. 1;

FIG. 3 shows a fluid flow diagram of a fluid heat management system in accordance with the present disclosure suitable for use with the gas turbine engine of FIG. 1;

FIG. 4 shows a graph of heat rejected from the engine to the oil contrasted with the heat capacity of the fuel at different stages of the engine flight cycle.

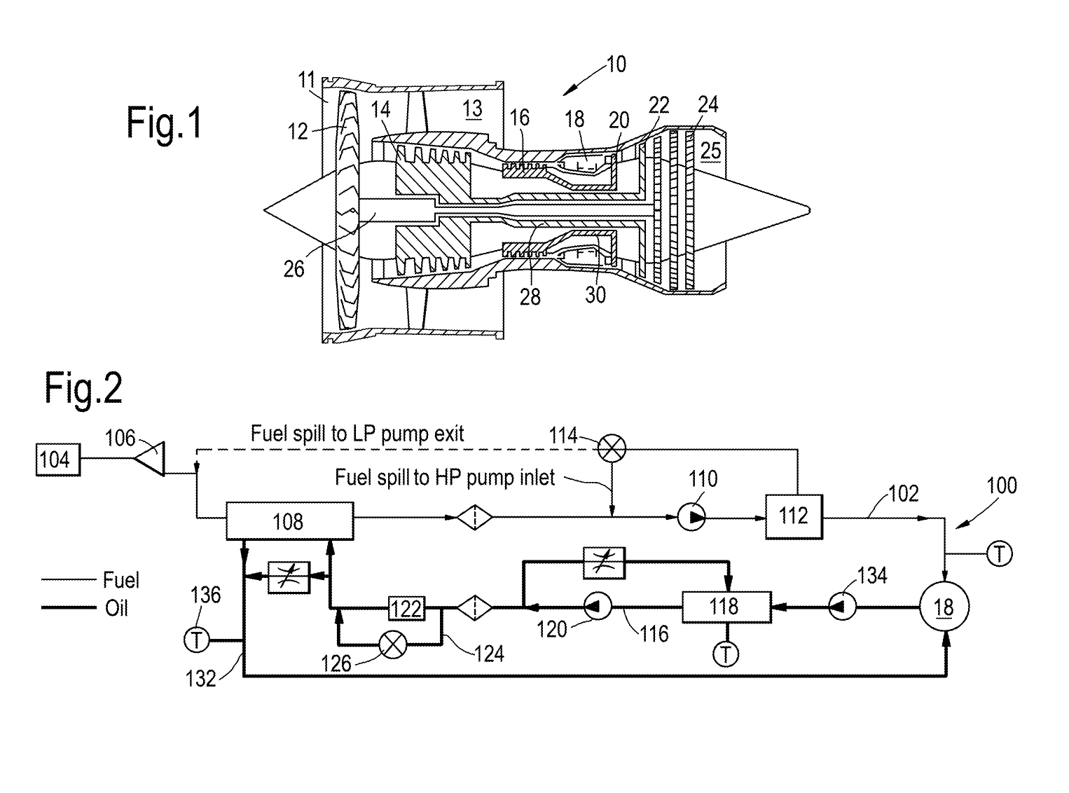

### DETAILED DESCRIPTION

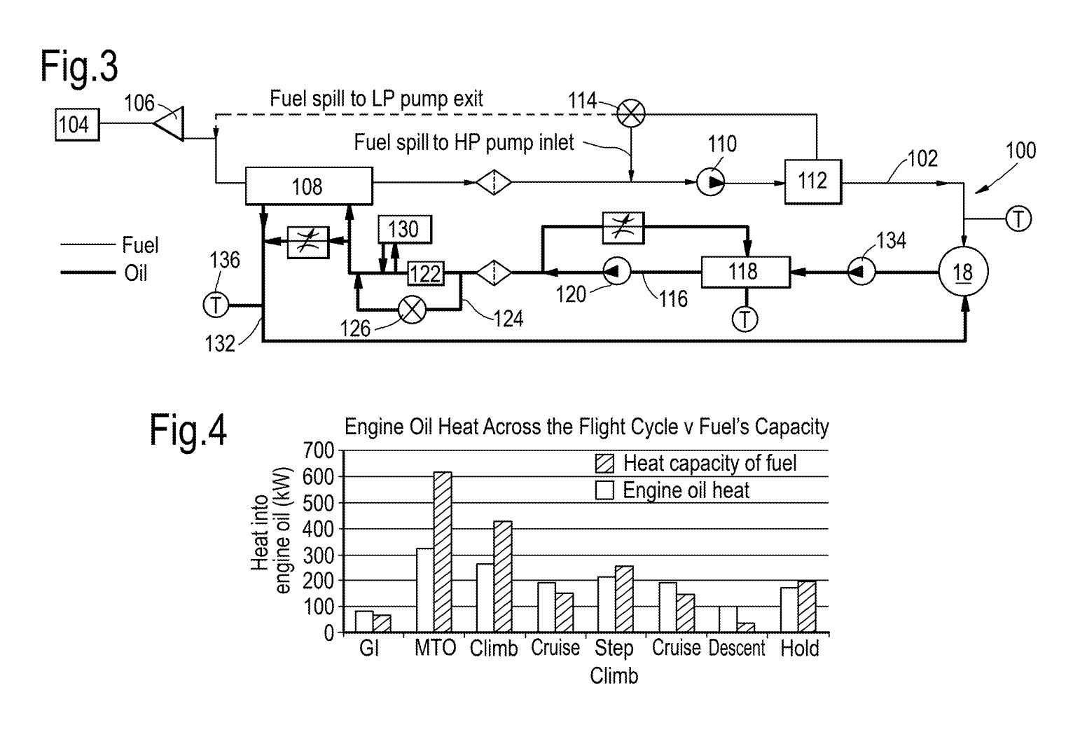

FIG. 3 shows a fluid flow diagram of a fluid heat management system 100 in accordance with the present disclosure.

The system 100 comprises a fuel line 102 which supplies liquid hydrocarbon fuel to the combustor 18. Fuel is supplied from a fuel tank 104, and pumped by a low pressure pump 106 through a fuel side of an oil to fuel heat exchanger (FOHE) 108, through a high pressure pump 110, through a hydromechanical unit (HMU) 112, and then to the combustor 18. The HMU 112 meters fuel to the combustor 18 by returning a portion of fuel received by the HMU 112 to either the inlet of the high pressure pump 110 or the inlet of the FOHE 108 in accordance with the position of a diverting valve 114. In general, under cold conditions, fuel is directed to the FOHE 108; while during normal operation, fuel is directed to the high pressure pump 110 inlet. Fuel is metered by the HMU 112 in accordance with signals provided by an engine controller (FADEC, not shown).

The system 100 further comprises an oil line 116. OH is provided to the oil line 116 from an oil tank 118 and is pumped by an oil feed pump 120 toward an oil side of an oil to air heat exchanger (AOHE) 122. An oil side of a further heat exchanger 130 is provided downstream of the AOHE 122. The system 100 includes an AOHE bypass arrangement 124 configured to selectively bypass oil around both the AOHE 122 and the further heat exchanger in accordance with the position of a bypass valve 126.

The further heat exchanger 130 comprise a phase change material (PCM) located in heat exchange relationship with oil passing through the further heat exchanger 130 in use. The PCM is a material which undergoes a phase change (i.e. changes from a solid, liquid or gaseous phase into a different phase) in response to a temperature change. The PCM is selected to undergo a phase change at a predetermined fuel target temperature. Preferably, the phase change is between a solid and a liquid at the fuel target temperature, so that the volume change of the material is relatively small. Where the fuel comprises hydrocarbon aviation fuel, the predetermined temperature is preferably approximately 110±20° C., and preferably 110±5° C. One suitable PCM may for example comprise a salt hydrate or a mixture of a salt and water. Suitable phase change materials include Magnesium chloride hexahydrate (MgCl₂.6H₂O) and hydrate of potassium aluminium sulphate (also known as Alum and having the chemical formula KAl(SO₄)₂.12H₂O). These salts have melting points of 117° C. and 91° C. respectively. Consequently, oil flowing through the oil line 116 is either heated or cooled by the PCM as it passes through the further heat exchanger, depending on whether the oil is respectively below or above the temperature of the PCM. Consequently, the oil is maintained, as far as possible, at approximately the predetermined target temperature.

Once the oil flow has passed through the further heat exchanger, it is then passed downstream to an oil side of the FOHE 108 where it is cooled further, by transferring heat to the engine fuel. Oil is then recirculated through a return line 132 to engine components to be cooled, such as bearings, where the oil is again heated. Oil is then passed back to the oil feed pump 120 by a scavenge pump 134 to be recirculated through the heat exchangers 108, 122, 130.

Magnesium chloride hexahydrate has a phase change temperature for the solid to liquid phase change of approximately 117° C., and has a melting enthalpy of approximately 400 kJ/l. It has been found that during the transition from cruise to descent power, the fuel flow rate drops by approximately a factor of 5 (for example, in one known engine, fuel flow rate drops from 0.7 kg/s to 0.14 kg/s). The rise in fuel temperature during this period is expected to be approximately 10° C., and the fuel is maintained at this higher temperature for approximately 10 minutes until the AOHE 122 is able to reject sufficient heat to reduce the temperature once more.

Consequently, it is estimated that in order to reduce the time at which the fuel is above the predetermined target temperature during the transition from cruise to descent power to zero, it is necessary to prevent 1.76 MJ of heat from reaching the FOHE 108. Consequently, assuming this heat can be transferred to the PCM with 100% efficiency, approximately 4.4 litres of Magnesium chloride hexahydrate is required. This is thought to be substantially less than the weight of an AOHE 122 that is capable of rejecting this amount of heat in this time frame. Consequently, the system of the present disclosure is significantly lighter than conventional solutions.

The system 100 is controlled as follows. During operation, a temperature sensor 136 senses the temperature of oil flowing out of the outlet of the oil side of the FOHE 108. If the oil is above a predetermined fuel target temperature (say 115° C.), the bypass valve 126 is shut, such that oil flows through the AOHE 122 and further heat exchanger 130. Consequently, a proportion of the heat is passed from the oil to bypass air, and a portion of the heat is passed to the PCM. However, initially, the capacity of the AOHE 122 is limited, so the proportion of heat transferred to the PCM is relatively large. Gradually, the AOHE capacity increases, and the capacity of the PCM decreases, as the PCM changes phase from solid to liquid, and so more heat is transferred to air by the AOHE. This transition in the proportion of heat absorbed by the PCM relative to heat rejected by the AOHE 122 is automatic, and requires no further control inputs beyond control of the valve 126 in dependence on FOHE 108 oil outlet temperature.

Once temperature sensor 136 detects that the temperature is below the fuel target temperature (say 105° C.), the bypass valve 126 is opened once more, and the heat exchangers 122, 130 are thereby bypassed. The PCM within the further heat exchanger 130 continues to be cooled by bypass air, thereby rejecting heat to the bypass stream. Consequently, the PCM changes phase once more to a solid. Once the PCM is converted to a solid, the PCM is once more ready to be used to cool the oil.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For example, the PCM may be located within the AOHE rather than in a separate heat exchanger. The PCM may be provided in different locations, for example, upstream of the AOHE, provided the PCM is located in thermal contact with the oil, upstream of the FOHE.

Aspects of any of the embodiments of the invention could be combined with aspects of other embodiments, where appropriate.

1. A fluid heat management system for an aircraft gas turbine engine, the system comprising:
an oil to air heat exchanger configured to transfer heat from engine oil to bypass air;
an oil to fuel heat exchanger configured to transfer heat from engine oil to fuel; and
a phase change material in thermal contact with oil upstream of the oil to fuel heat exchanger, wherein the phase change material has a phase change temperature at a predetermined fuel target temperature.

2. A system according to claim 1, wherein phase change material is provided within a further heat exchanger.

3. A system according to claim 2, wherein the further heat exchanger is provided downstream of the oil to air heat exchanger.

4. A system according to claim 1, wherein the phase change material is located within one of the oil to air heat exchanger and the oil to fuel heat exchanger.

5. A system according to claim 4, wherein the system comprises a bypass arrangement configured to selectively bypass oil around at least the oil to air heat exchanger.

6. A system according to claim 1, wherein the target temperature is between 100° C. and 120° C.

7. A system according to claim 1, wherein the phase change material comprises a salt hydrate of the general formula MₙH₂O, where M is a salt.

8. A system according to claim 7, wherein the phase change material comprises one or more of Magnesium chloride hexahydrate (MgCl₂.6H₂O) and hydrate of potassium aluminium sulphate (KAl(SO₄)₂.12H₂O.

9. A system according to claim 1, wherein the system comprises between 1 and 10 litres of phase change material.

10. A gas turbine engine comprising a gas turbine engine fluid heat management system in accordance with claim 1.

11. A method of managing heat within an oil system of a gas turbine engine, the method comprising:
transferring heat from oil to fuel via an oil to fuel heat exchanger;
selectively transferring heat from oil to air via an oil to air heat exchanger; and
selectively transferring heat from oil to a phase change material having a phase change temperature at a predetermined target fuel temperature.
